(19) United States
(12) Patent Application Publication
(10) Pub. No.: US 2024/0228067 A1
(43) Pub. Date: Jul. 11, 2024

(54) THERMOMECHANICAL STRUCTURE FOR FOCAL PLANE OF A SPACE OBSERVATION INSTRUMENT

(71) Applicant: AIRBUS DEFENCE AND SPACE SAS, Toulouse cedex 4 (FR)

(72) Inventors: Delphine CARPONCIN, Toulouse cedex 4 (FR); Sébastien LEFOLL, Toulouse cedex 4 (FR); Christophe FIGUS, Toulouse cedex 4 (FR)

(21) Appl. No.: 18/557,222

(22) PCT Filed: Apr. 14, 2022
(86) PCT No.: PCT/FR2022/050707

§ 371 Date: Oct. 25, 2023

(30) Foreign Application Priority Data
Apr. 26, 2021 (FR) FR2104329

(51) Int. Cl. B64G 1/50; B33Y 80/00; B64G 1/10; B64G 1/58

(52) U.S. Cl. CPC B64G 1/503; B64G 1/1028; B64G 1/58; B33Y 80/00

(57) ABSTRACT

A thermoregulated thermomechanical structure for a focal plane suitable for operating in a space environment is disclosed having an interface for supporting dissipative electronic equipment, the structure being monolithic, metallic and including a radiator and a first two-phase heat-transfer fluid transport cavity, extending within the radiator and providing direct thermal transport between the interface and the radiator. The structure also includes a second cavity encapsulating a phase change material.

### TECHNICAL FIELD

The present invention belongs to the field of space systems, particularly the thermal control of on-board equipment in a spacecraft such as an artificial satellite, and more particularly relates to a thermomechanical structure for a focal plane of a space observation instrument and a focal plane comprising such a structure. The present invention applies directly to Earth observation satellites.

### PRIOR ART

In a space observation instrument, such as a telescope or an interferometer, and more generally in any similar optical detection unit, the focal plane makes it possible to support various optical detectors or other electronic equipment and produces the image focus wherein the optical system (mirrors, lenses, etc.) focus the incident photons to thus form the images of the objects observed.

Therefore, the focal plane needs to be maintained at the nominal operating temperatures of the detectors that it supports, and is therefore of the utmost importance in the performance of the observation instrument.

Currently, focal planes are generally obtained by a complex assembly of mechanical and thermal parts comprising, inter alia, a plate made of expensive ceramic material whereon ten or so parts are attached. The integration process is generally long and delicate.

FIG. 1 shows one example of a focal plane according to the prior art consisting of more than twenty or so assembled parts, mainly made of silicon carbide SiC and aluminium, wherein heat pipes are pressed along the side radiators and are thermally coupled to the dissipative electronic equipment.

The document FR3040777, entitled “optical detection assembly including an improved thermal control optical detector, observation instrument and satellite including such an optical detection assembly”, describes a thermal control device for maintaining a detector at a predefined operating temperature, this device comprising a plate made of ceramic, an adjusting shim and a Phase Change Material (PCM) housed in a cavity of the shim, without being in contact with the shim or the plate, but by being directly in contact with the detector. However, this solution remains complex to implement particularly for focal planes of small and complex structures.

Usually, heat pipes are used to provide the thermal transport between the hot points and the cold points of a focal plane as shown in the example of FIG. 1. These heat pipes exist in various forms and designs.

The document WO2014/013035, entitled “thermal control device”, describes for example the implementation of a heat pipe to thermally control electronic equipment in a satellite, comprising thermal interfaces in the form of flat chambers with porous structure connected to heat-transfer tubes with grooved structures.

Thus, there is a need to simplify existing thermal control solutions particularly by reducing the number of assembled parts while integrating an effective thermal control for the targeted space applications.

### DESCRIPTION OF THE INVENTION

The present invention aims to overcome the drawbacks of the prior art disclosed above and proposes a solution for producing a focal plane with a reduced number of structural elements, having thermal performances and mechanical performances at least equivalent to the focal planes of the prior art, while remaining competitive regarding production costs.

To this end, the object of the present invention is a thermoregulated thermomechanical structure for a focal plane suitable for operating in a space environment, comprising at least one first interface for supporting at least one first dissipative electronic equipment. This structure is remarkable in that it is metallic and in that it comprises at least one radiator for dissipating heat into the space environment and at least one first heat energy transport cavity via a phase change fluid that is in the liquid or gaseous state, said first cavity extending partially within said radiator and providing direct thermal transport between said first interface and said radiator, said structure further comprising at least one second heat energy storage cavity encapsulating a phase change material that is in the solid or liquid state.

Advantageously, each first cavity is distinct and disjoint from each second cavity.

According to a particular feature of the invention, the thermomechanical structure comprises a single first cavity and a plurality of second cavities of which at least some of these second cavities are disposed as close as possible to the first cavity.

More particularly, the first cavity extends as close as possible to the first interface and contributes to homogeneously spreading out the energy generated at the first dissipative electronic equipment.

Advantageously, the first cavity comprises an internal geometry of porous type located at the first interface, providing a multi-directional diffusion of the heat energy, the internal geometry of porous type being prolonged by an internal geometry comprising grooves favouring a diffusion of the heat energy along these grooves, towards the radiators.

According to a particular feature of the invention, the structure comprises at least two radiators, disposed laterally and on either side of the first interface, the first cavity extending into these radiators.

According to one embodiment of the invention, the thermomechanical structure comprises at least one second interface for supporting at least one second dissipative electronic equipment, the first cavity extending as close as possible to said second interface and providing direct thermal transport between said second interface and said radiator.

Advantageously, the first cavity comprises an internal geometry of porous type located at said second interface, providing a multi-directional diffusion of the heat energy and contributing to homogeneously spreading out the energy generated at said second dissipative electronic equipment.

According to a particular feature of the invention, the thermomechanical structure comprises a pair of first interfaces and a pair of second interfaces arranged symmetrically along a median plane, for supporting respectively a pair of first dissipative electronic equipment and a pair of second dissipative electronic equipment arranged symmetrically along a median plane.

Advantageously, the thermomechanical structure comprises a plurality of junction elements between the first interface and the second interface and wherein the first two-phase cavity extends.

Advantageously, the thermomechanical structure is made of a single monolithic block consisting of a plurality of sub-assemblies generated by additive layer manufacturing, each sub-assembly being able to contain a portion of the first cavity, a portion of the second cavity, a portion of the first interface, and/or a portion of the radiator.

According to a particular feature of the invention, the thermomechanical structure further comprises a plurality of attachment appendages wherein the first cavity extends and intended to receive an add-on radiator for dissipating heat into the space environment.

Another object of the present invention is a focal plane suitable for operating in a space environment, comprising a thermomechanical structure such as described and at least one photosensitive sensor attached to the first interface of said structure.

More particularly, this focal plane comprises at least one electronic processing and control component in communication link with said photosensitive sensor, this electronic processing and control component being attached on the second interface of the thermomechanical structure.

Another object of the present invention is a space observation instrument comprising such a focal plane, and an artificial satellite comprising such a space observation instrument.

More particularly, the artificial satellite comprises at least one dissipative electronic component attached on an interface of a thermomechanical structure as described.

One advantage of the present invention resides particularly in a simplification of the process for implementing a focal plane.

Another advantage is its reduced production cost in relation to the costs generally induced for implementing focal planes.

Another advantage resides in the effectiveness of the thermal control of the set of detectors forming the focal plane making it possible to optimise the quality of the signals generated by the detectors. A heat energy transport cavity, comprising a phase change fluid that is in the liquid or gaseous state, and a heat energy storage cavity, encapsulating a phase change material that is in the solid or liquid state, are advantageously combined in a one-piece metallic structure and make it possible to increase the thermal stability capacities of the structure comprising these two cavities.

The storage cavities and the transport cavities will advantageously be disposed as close as possible to one another in such a way as to limit the thickness of metallic material to be passed through by the heat flux.

Advantageously, the enhanced thermal performances make it possible to expect a weight savings greater than 5% for example for a thermomechanical structure made of INVAR in relation to a conventional focal plane made of SiC.

The fundamental concepts of the invention being above disclosed in the most elementary form thereof, other details and features of the present invention will become more clearly apparent upon reading the following description and with regard to the appended drawings, given by way of non-limiting examples.

### BRIEF DESCRIPTION OF THE FIGURES

The figures are given purely by way of illustration for a better understanding of the invention without limiting its scope. The various elements may be shown schematically and are not necessarily to the same scale. In all of the figures, identical or equivalent elements bear the same numerical reference.

It is thus illustrated in:

FIG. 1: (already mentioned) a focal plane of the prior art;

FIG. 2: a rear perspective view of a focal plane according to the invention;

FIG. 3: a rear perspective view of the thermomechanical structure of the focal plane of FIG. 2;

FIG. 3bis: a view schematically illustrating the circulation of the two-phase fluid in its liquid form

FIG. 4: a front perspective view of the thermomechanical structure of the focal plane of FIG. 2;

FIG. 4bis: a view illustrating an example of two-phase cavity in a thermomechanical structure according to the invention;

FIG. 5: a top view of the thermomechanical structure of the focal plane of FIG. 2;

FIG. 6: a perspective side view of the focal plane of FIG. 2;

FIG. 7: an exploded view of the focal plane of FIG. 2;

FIG. 8: a schematic view of an example of satellite equipped with an observation instrument.

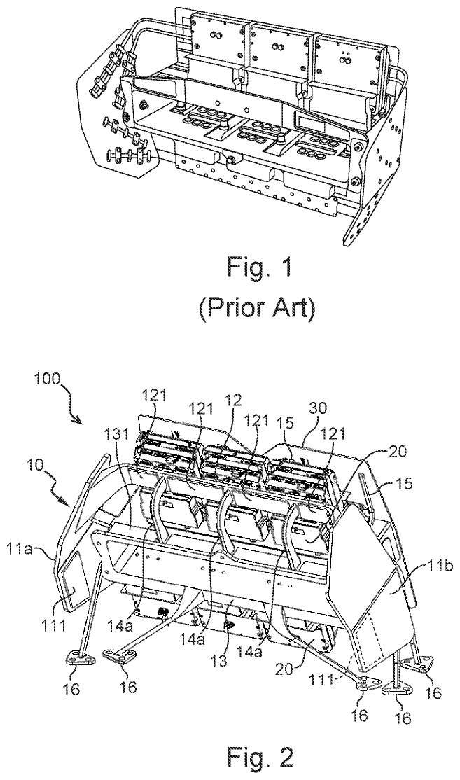

### DETAILED DESCRIPTION OF EMBODIMENTS

It should be noted that certain technical elements well known to the person skilled in the art are described here to avoid any inadequacy or ambiguity in the understanding of the present invention.

In the present description, reference is made to a thermomechanical structure for a focal plane, primarily intended for a space observation instrument. This non-limiting example is given for a better understanding of the invention and does not exclude using the thermomechanical structure according to the invention in other space systems.

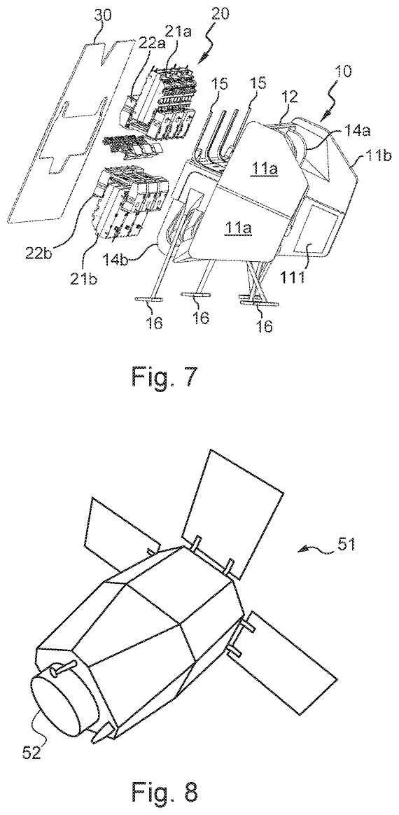

In the remainder of the description, the expression “thermomechanical structure” designates a structure designed mechanically and thermally to both support equipment and regulate their temperatures. The term “satellite” designates an artificial satellite. An example of satellite 51 equipped with an observation instrument 52 is for example shown in FIG. 8. The synonymous expressions “Additive Layer Manufacturing” (ALM) and “3D printing” are used indifferently to designate any method for forming a part by stacking successive layers or by adding any computer-aided design material.

FIG. 2 shows a focal plane 100 according to the invention, comprising a metallic thermomechanical structure 10, for example in a single block, as well as electronic equipment 20 attached to said thermomechanical structure. The thermomechanical structure 10 comprises for example two radiators disposed laterally. An add-on radiator 30 is for example attached to the thermomechanical structure. This add-on radiator is for example in the form of a plate 30 that is thermally conductive on contact with the thermomechanical structure 10. Each radiator makes it possible to dissipate heat towards the space environment wherein the focal plane operates.

FIG. 6 shows a focal plane comprising a thermomechanical structure 10 according to the invention. FIG. 7 shows an exploded view illustrating the mounting of the focal plane, this mounting being facilitated particularly by the reduced number of parts.

The focal plane 100 here comprises a plurality of electronic equipment 20 attached to the thermomechanical structure 10 of which a pair of photosensitive sensors 22a and 22b each in communication link with an electronic component 21a and 21b for processing and controlling the data generated by the photosensitive sensors. The photosensitive sensors 22a and 22b are disposed symmetrically in relation to a median plane. The electronic processing and control components 21a and 21b are also disposed, one in relation to the other, symmetrically in relation to the median plane.

Thus, in the thermomechanical structure, the interfaces for the photosensitive sensors 22a and 22b are disposed symmetrically in relation to the median plane and the interfaces 12 for the electronic components 21a and 21b are also disposed symmetrically in relation to the median plane.

Appendages 15 of the thermomechanical structure come around the periphery of the thermomechanical structure to receive the add-on radiator 30. These appendages 15 are for example in the form of right-angle curved lugs. The add-on plate 30 is optional according to the configurations requiring for example an additional means of cooling in addition to the radiators of the thermomechanical structure. In addition, the mounting of the focal plane and particularly of its electronic components is facilitated.

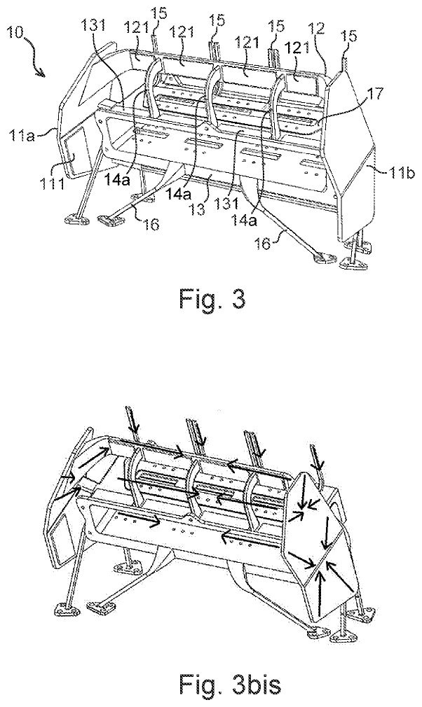

As shown in FIG. 3, the thermomechanical structure 10, according to the example of embodiment illustrated, is shaped to adapt to particular equipment and to a given mission profile. The thermomechanical structure 10 particularly comprises two side radiators 11a and 11b.

Alternatively, the thermomechanical structure may comprise a single radiator.

The thermomechanical structure may also comprise a larger number of radiators, such as for example four radiators each connected to the central portion 13.

As shown in FIG. 3, the thermomechanical structure comprises a central portion 13 located between the two radiators and forming two interfaces 17 for the photosensitive sensors. The central portion is laterally prolonged by the two radiators of the thermomechanical structure.

The thermomechanical structure 10 also comprises two crossmembers 12 to form an interface for each of the electronic control components associated with one of the photosensitive sensors. These crossmembers also prolong laterally by the two radiators 11a and 11b.

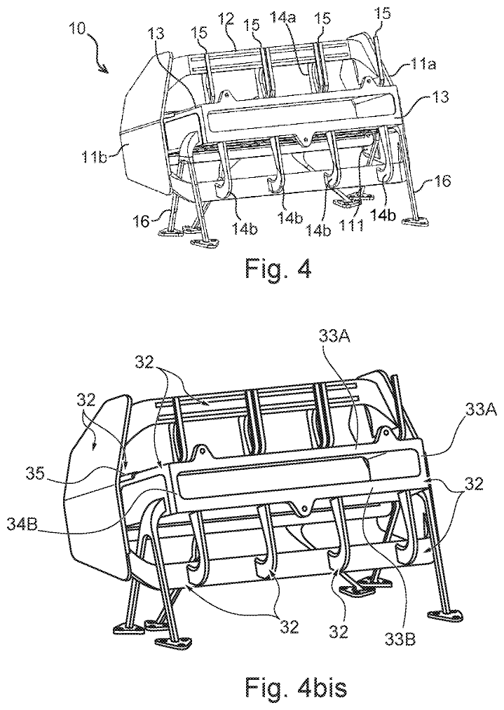

The thermomechanical structure 10 here comprises a plurality of junction elements 14a, being for example in the form of hoops, joining each interface of a photosensitive sensor to an interface of a control electronic component. Thus, the heat of the electronic control components may be removed via the radiators 11a and 11b that are used for the thermal regulation of the interfaces of the photosensitive sensors. The hoops 14a join the crossmember 12 to the central portion 13 and extend into planes substantially perpendicular to a longitudinal axis of the crossmember. Apart from the upper hoops 14a, the thermomechanical structure 10 includes lower hoops 14b, that can be seen in FIG. 4 for example, extending between the central portion 13 and a lower crossmember connecting the side radiators 11a and 11b.

The thermomechanical structure 10 also comprises attachment legs 16. These attachment legs 16 each comprise a baseplate provided with holes for installing the focal plane 100 on an instrument-holder platform of a satellite for example, via suitable means such as screws or bolts.

As shown in FIG. 2, the metallic thermomechanical structure 10 makes it possible to support the electronic equipment 20 and to regulate their temperatures to maintain their temperature within a range adapted to their nominal operation. To this end, the metallic thermomechanical structure 10 is partially hollow so as to define a hermetic cavity wherein a heat-transfer fluid circulates in a two-phase and continuous way, thus providing a thermal transport by phase transition between the hot points and the cold points of the focal plane. The transport of the heat energy is thus provided between hot areas towards cold areas of the thermomechanical structure 10.

As shown in FIG. 4bis, this cavity 32, referred to as two-phase, extends for example into the side radiators 11a and 11b and into the central portion 13 supporting the photosensitive sensors. The central portion 13 has for example a substantially parallelepiped rectangular shape comprising a substantially parallelepiped through opening. The central portion 13 thus consists of two longitudinal, substantially rectangular, partitions 33A and 33B, prolonged by two substantially rectangular side partitions 34A and 34B. The longitudinal partitions 33A and 33B receive on their outer face the interfaces for the photosensitive sensors.

The longitudinal partitions 33A and 33B are prolonged moreover by the hoops 14a and 14b connecting with the crossmember 12 as well as by the L-shaped appendages 15 for attaching the add-on radiator. The side partitions 34A and 34B are prolonged, along their outer face, by an arm 35 wherein the two-phase cavity 32 extends and producing a connection with the radiators of the thermomechanical structure. The two-phase cavity 32 may also extend into the crossmembers 12. The two-phase cavity 32 extends for example also into the hoops 14a connecting the crossmembers to the central portion 13. The two-phase cavity 32 may also extend into the appendages 15 for attaching the add-on radiator. Thus, the liquid and the vapour may circulate simultaneously in the two-phase cavity. Indeed, the two-phase cavity is made of grooves or pores contributing to transporting the liquid and of hollow areas wherein the vapour circulates. The first cavity may for example perform two functions: spreading out the heat under the detectors, provided by an internal geometry of porous type at this location of the cavity, and transporting the heat from the detectors to the radiators, provided by internal geometries of groove types between the detectors and the radiators.

For example, a single two-phase cavity may be provided connecting by a continuous flux all of the hot points to all of the cold points of the thermomechanical structure. FIG. 3bis shows an example of circulation of the heat-transfer fluid in its liquid form, from the cold points to the hot points. For greater clarity of the diagram in FIG. 3bis, the circulation of the vapour has not been shown.

A plurality of two-phase cavities may also be envisaged each connecting by a continuous flux the hot points to the cold points of the thermomechanical structure. As shown in FIG. 3, hot points considered firstly correspond to the interfaces 17 for the photosensitive sensors. The interface 17 is for example as close as possible to the two-phase cavity, that is to say that the smallest possible thickness of the wall separating the two-phase cavity of the interface for attaching the photosensitive sensor is chosen, while respecting the mechanical strength constraints. Secondly, the electronic data processing and control components are cooled by the same thermal circuit. The two-phase cavity comes for example as close as possible to this other interface. The heat is removed towards the radiators.

It may also be envisaged to cool a single interface for a photosensitive sensor or for another type of electronic component.

The cavity for the two-phase fluid makes it possible to circulate vapour from the hot points to the cooling points where the vapour condenses into liquid. This liquid circulates in the opposite direction by capillarity, from the cold points to the hot points. The size of the pores or of the grooves wherein the liquid circulates, is for example chosen decreasing by going from the cold points to the hot points.

In the hoops 14a, the liquid phase circulates, for example, from the cavity 121 in the crossmember 12 to the cavity 131 in the central portion 13, whereas the vapour circulates from the cavity 131 in the central portion 13 to the cavity 121 in the crossmember 12.

As shown in FIG. 3, the side radiators 11a and 11b are arranged on either side of the central portion 13. The radiators 11a and 11b here have a slightly bent extended plate shape of concavity oriented inwardly of the thermomechanical structure. The two side radiators 11a and 11b indeed constitute opposite thermal dissipation ends towards the space environment.

The crossmember 12, according to the example of embodiment illustrated, is a substantially prismatic tubular beam terminating with two ends flared and curved towards the side radiators 11a and 11b. Thus, the heat-transfer fluid contained in the thermomechanical structure 10 may circulate between the radiators and the crossmember 12.

In the same way, the heat-transfer fluid circulates between the radiators and the central portion 13 supporting the interfaces 17 for the photosensitive sensors.

The thermomechanical structure further comprises one or more cavities receiving a phase change material (PCM). These cavities for the PCM may be disposed as close as possible to the two-phase cavity or in a solid portion of the thermomechanical structure. The radiators each include for example a cavity 111 suitable for receiving a phase change material (PCM).

Using these cavities for PCM, in addition to the two-phase cavities arranged in the volume of certain portions of the thermomechanical structure 10, makes it possible to improve the performance of the thermal control of said thermomechanical structure and, thereby, of the focal plane 100.

The PCM cavity or cavities are suitable for storing, for example, heat energy. Thus, the temperature maximums may be absorbed. This energy absorption is optimised via the internal structure of the PCM cavities: the internal surface of the storage cavity may particularly consist of a lattice structure in connection with the wall of the cavity in such a way as to increase the exchange surfaces between the metal and the PCM.

The energy absorption will make it possible to limit the amount of energy to be transported to the radiators during the image capture phases. The energy stored will for example be returned and removed by the radiators, during periods where the radiators are used less.

The crossmember 12 may also include, on its central portion, a plurality of cavities 121 for PCM.

The central portion 13, according to the example of embodiment illustrated, may also include cavities 131 for PCM in order to improve the cooling of equipment, these cavities able to be placed within the immediate vicinity of the interfaces 17 of the sensors to be cooled.

The thermomechanical structure 10 may thus comprise a plurality of cavities 111, 121 and 131 for PCM distributed in different locations chosen to optimise the thermal control of the focal plane 100. The PCM is adapted depending on the locations of the PCM cavities depending on whether they are positioned close to cold points or hot points. Due to the phase changes of the PCM, these cavities are sealed.

The PCM is chosen depending on its phase change temperature, generally melting, itself chosen depending on the operating temperature of the equipment. Indeed, a PCM provides a latent heat transfer, in other words, it is capable of storing or yielding energy by simple change of phase, and this isothermally (at a temperature equal to its phase change temperature).

The lugs 15, according to the example of embodiment illustrated in FIG. 4, are six in number and in the form of tubes curved at their base, the bases being connected to the central portion 13. The elongated portion of the lugs 15 is for its part attached to the add-on thermal dissipation plate 30 as shown in FIG. 2.

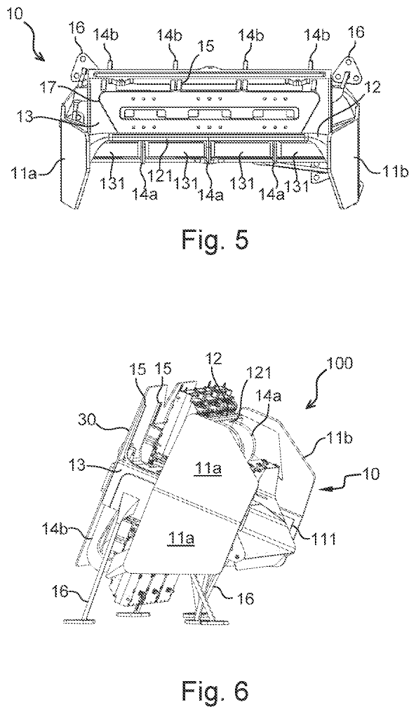

As shown in FIGS. 3 to 5, the thermomechanical structure 10 is made in a single metallic block by an additive layer manufacturing method. The thermomechanical structure made of a single monolithic block may consist of a plurality of sub-assemblies each generated by additive layer manufacturing (ALM), then secured together, for example by welding.

Each sub-assembly may contain a portion of the two-phase cavity. Each sub-assembly may also contain a portion of one or more cavities for PCM. Each sub-assembly may also contain a portion of one or more interfaces for the photosensitive sensors. Each sub-assembly may also contain a portion of one or more interfaces for the electronic control equipment. Each sub-assembly may also contain a portion of a radiator of the thermomechanical structure.

One or more cavities or the interfaces may also be produced in the same sub-assembly produced by ALM. A radiator may also be produced in the same sub-assembly produced by ALM.

The additive layer manufacturing method makes it possible to produce the thermomechanical structure 10, with an optimisation of the shapes and volumes of the two-phase hollow portions and of the PCM cavities. Additive layer manufacturing by the powder bed laser fusion technique may for example be used, the latter making it possible to produce metallic parts of thin, complex and intricate shapes.

Preferably, the thermomechanical structure 10 is made of titanium or Invar, these materials having very low expansion coefficients and therefore providing very good mechanical stability of the thermomechanical structure 10 according to the invention.

The thermomechanical structure for a focal plane according to the invention, thus provides a noteworthy industrial advantage and opens up new prospects for producing structures that are thermally and mechanically more efficient.

It is clear from the present description that certain elements of the thermomechanical structure may be modified, replaced or eliminated and that certain adjustments may be made to their shapes and dimensions, without in as much departing from the scope of the invention.

1. A thermoregulated thermomechanical structure-for a focal plane suitable for operating in a space environment, comprising at least one first interface for supporting at least one first dissipative electronic equipment, wherein said structure is metallic and further comprises at least one radiator for dissipating heat into the space environment and at least one first heat energy transport cavity via a phase change fluid that is in the liquid or gaseous state, said first cavity extending partially within said radiator and providing direct thermal transport between said first interface and said radiator, said structure further comprising at least one second heat energy storage cavity encapsulating a phase change material that is in the solid or liquid state.

2. The thermoregulated thermomechanical structure according to claim 1, wherein each first cavity is distinct and disjoint from each second cavity.

3. The thermoregulated thermomechanical structure according to claim 1, further comprising a single first cavity and a plurality of second cavities of which at least some of these second cavities are disposed as close as possible to the first cavity.

4. The thermoregulated thermomechanical structure according to claim 1, wherein said first cavity extends as close as possible to said first interface and contributes to homogeneously spreading out the energy generated at said first dissipative electronic equipment.

5. The thermoregulated thermomechanical structure according to claim 1, wherein said first cavity comprises an internal geometry of porous type located at said first interface, providing a multi-directional diffusion of the heat energy, the internal geometry of porous type being prolonged by an internal geometry comprising grooves favouring a diffusion of the heat energy along these grooves, towards the radiators.

6. The thermoregulated thermomechanical structure according to claim 1, further comprising at least two radiators (Ha, 11b), disposed laterally and on either side of said first interface, said first cavity extending into these radiators.

7. The thermoregulated thermomechanical structure according to claim 1, further comprising at least one second interface-for supporting at least one second dissipative electronic equipment, said first cavity extending as close as possible to said second interface and providing direct thermal transport between said second interface and said radiator.

8. The thermoregulated thermomechanical structure according to the preceding claimclaim 1, wherein said first cavity comprises an internal geometry of porous type located at said second interface, providing a multi-directional diffusion of the heat energy and contributing to homogeneously spreading out the energy generated at said second dissipative electronic equipment.

9. The thermoregulated thermomechanical structure according to claim 7, further comprising a pair of first interfaces and a pair of second interfaces arranged symmetrically along a median plane, for supporting respectively a pair of first dissipative electronic equipment and a pair of second dissipative electronic equipment arranged symmetrically along a median plane.

10. The thermoregulated thermomechanical structure according to claim 7, further comprising a plurality of junction elements between said first interface and said second interface and wherein said first two-phase cavity extends.

11. The thermoregulated thermomechanical structure according to claim 1, it iswherein the structure is made of a single monolithic block consisting of a plurality of sub-assemblies generated by additive layer manufacturing, each sub-assembly being able to contain a portion of said first cavity, a portion of said second cavity, a portion of said first interface, and/or a portion of said radiator.

12. The thermoregulated thermomechanical structure according to claim 1, further comprising a plurality of attachment appendages wherein the first cavity extends and intended to receive an add-on radiator for dissipating heat into the space environment.

13. A Focal plane suitable for operating in a space environment, comprising the thermomechanical structure according to claim 1 and at least one photosensitive sensor attached to the first interface of the thermomechanical structure.

14. The Focal plane according to claim 13, further comprising at least one electronic processing and control component in communication link with said photosensitive sensor, this electronic processing and control component being attached on said second interface of the thermomechanical structure.

15. A space observation instrument, it comprises a comprising the focal plane according to claim 13.

16. An artificial satellite, it comprising the space observation instrument according to claim 15.

17. An artificial satellite, comprising at least one dissipative electronic component attached on an interface of aof the thermomechanical structure according to claim 1.
